(19) United States
(12) Patent Application Publication
(10) Pub. No.: US 2011/0027164 A1
(43) Pub. Date: Feb. 3, 2011

(54) METHOD AND APPARATUS FOR SYNTHESIZING CARBON NANOTUBES USING ULTRASONIC EVAPORATION

(75) Inventors: Nam-Jo JEONG, Daejeon (KR); Yong-Seog Seo, Daejeon (KR)

Correspondence Address: ARENT FOX LLP, 1050 CONNECTICUT AVENUE, N.W., SUITE 400, WASHINGTON, DC, 20036, US

(73) Assignee: KOREA INSTITUTE OF ENERGY RESEARCH, Daejeon (KR)

(21) Appl. No.: 12/822,662

(22) Filed: Jun. 24, 2010

Related U.S. Application Data
(62) Division of application No. 11/723,785, filed on Mar. 22, 2007.

(30) Foreign Application Priority Data
Mar. 28, 2006 (KR) 2006/0027795
Feb. 9, 2007 (KR) 2007/0013553

(51) Int. Cl. D01F 9/12; B82Y 40/00

(52) U.S. Cl. 423/447.3; 977/742

(57) ABSTRACT

Disclosed herein is an apparatus and method for synthesizing carbon nanotubes, including a fuel supply unit for supplying a large amount of liquid metal catalyst mixture using a syringe pump for quantitatively supplying a liquid metal catalyst mixture, mixed with hydrocarbon-based liquid carbon sources such as xylene, toluene, benzene and the like, and metal catalytic particles, such as iron, nickel, cobalt, molybdenum and the like, and a general liquid pump for supplying a liquid metal catalyst mixture depending on the amount thereof; an evaporation unit for evaporating and atomizing the liquid metal catalyst mixture supplied from the fuel supply unit into precursors having a uniform size on the nanometer scale; a carrier gas supply unit for transferring particles atomized in the evaporation unit to a reactor and transferring carrier gas, having an influence on the synthesis of carbon nanotubes, to the reactor; a horizontally oriented reaction unit for synthesizing carbon nanotubes in large quantities using the carrier gas supplied from the carrier gas supply unit and the precursors formed in the evaporation unit; a filtering unit comprising a filter for filtering residual particles among the atomized particles synthesized into carbon nanotubes in the horizontally oriented reaction unit and some of the carbon nanotubes synthesized in the vapor phase; and a vacuum generation unit comprising a vacuum pump configured to be connected with the filtering unit, decrease pressure in the reactor, and remove oxygen remaining in the reactor, or a continuous collection unit in the case where the apparatus includes a vertical type reaction unit.

### CROSS-REFERENCE TO RELATED APPLICATIONS

This is a Divisional application which claims the benefit of pending U.S. patent application Ser. No. 11/723,785, filed on Mar. 22, 2007, and claims priority of Korean Patent Application No. 0027795/2006, filed on Mar. 28, 2006, and Korean Patent Application No. 0013553/2007, filed on Feb. 9, 2007. The disclosures of the prior applications are hereby incorporated herein in their entirety by reference.

### BACKGROUND OF THE INVENTION

1. Field of the Invention

The present invention relates to a method and apparatus for synthesizing carbon nanotubes using ultrasonic evaporation and, more particularly, to a method and apparatus for synthesizing carbon nanotubes, in which precursors having uniform sizes, composed of metal catalytic particles, carbon atoms and hydrogen atoms, are produced, either in large quantities or continuously, by instantaneously evaporating and atomizing a liquid metal catalyst mixture including hydrocarbon liquid fuels and metal catalytic particles using a control system for automatically controlling operation time and intensity, operated by an ultrasonic vibration method, thereby synthesizing carbon nanotubes cheaply and at high efficiency by growing the produced precursors on large area substrates in large quantities, or synthesizing carbon nonotubes continuously using the produced precursors through continuous reaction and collection.

2. Description of the Related Art

Carbon nanotubes are a tubular material having a size on the nanometer scale, and are composed of carbon atoms. Further, the carbon nanotube is a new material having a structure in which a graphite sheet is rolled to have a diameter on the nanometer scale, and is a typical nano-material for nano-technology.

Since Iijima discovered carbon nanotubes in 1991, various peculiar quantum phenomena, which are exhibited on a small scale due to the quasi one-dimensional structure of the carbon nanotubes, have been observed. Since the carbon nanotubes have excellent mechanical and chemical properties, exhibit semi or metallic properties that depend on the structure thereof, are small in diameter and long, and have a cavity inner part, they exhibit excellent device properties in flat panel display devices, transistors, energy storage devices, etc., and are highly applicable to various electronic devices having a size on the nanometer scale.

The major applications of carbon nanotubes include emission source of various apparatuses, Vacuum Fluorescent Displays (VFD), white light sources, Field Emission Displays (FED), lithium-ion secondary battery electrodes, fuel cell for hydrogen storage, nano wires, AFM/STM tips, single electron devices, gas sensors, minute parts for medical engineering and high-functionalized composites, and the like.

Recently, as the fact that carbon nanotubes have strong ability to adsorb environmental materials thereto is known, the application of carbon nanotubes to environmental fields is gradually increasing.

In practice, since the carbon nanotubes have a nano-sized hexagonal structure, they have a high specific surface area as porous nano-materials. For this reason, carbon nanotubes have attracted strong interests with respect to uses for the energy storage and the adsorption of harmful materials.

Recently, it has been reported that, when the Langmuir's constant of carbon nanotubes to dioxins, which is a class of toxic materials harmful to the human body, was compared with the Langmuir's constant of activated carbon to dioxins, carbon nanotubes had adsorption capacity improved ten times or more over that of the activated carbon. Thus, the scope of application of carbon nanotubes in environmental fields is increasing. Furthermore, because of such excellent physical and chemical applicability, research on the carbon nanotubes is being actively conducted all over the world, and human resources involved in research on the carbon nanotubes is increasing.

The structures of carbon nanotubes are classified into zigzag structures, armchair structures and chiral structures depending on structural characteristics related to how the graphite sheet is rolled to form carbon nanotube.

Further, the carbon nanotubes are classified into single-walled carbon nanotubes, including one graphite sheet, double-walled carbon nanotubes, including two graphite sheets, and multi-walled carbon nanotubes, including more than two graphite sheets, depending on the number of rolled graphite sheets. Accordingly, the carbon nanotubes exhibit various physical, chemical and electrical characteristics.

Generally, methods of synthesizing carbon nanotubes can be roughly classified into arc discharge methods, laser ablation methods, and chemical vapor deposition (CVD) methods.

From the arc discharge method, carbon nanotubes is synthesized by obtaining the energy source necessary using a discharge phenomenon, in which graphite rods are electrically discharged. In this method, although high-quality carbon nanotubes can be synthesized, there are disadvantages in that the purity of the obtained products is low and in that it is not suitable for the mass production of carbon nanotubes. An example of the application of this arc discharge method is a plasma synthesis method.

The laser ablation method is also a method of synthesizing carbon nanotubes by instantaneously generating high-energy through a laser. The laser ablation method has advantages in that the produced carbon nanotubes are relatively straight and have high quality, but has disadvantages in that the energy consumption of apparatus is necessary for synthesis. Further, these methods have disadvantages in that additional purification are required in order to realize high purity after the synthesis of carbon nanotubes, and in that it is difficult to control the structures of the carbon nanotubes and grow the carbon nanotubes vertically.

The chemical vapor deposition (CVD) method is a method of synthesizing carbon nanotubes using a gaseous carbon source (sometimes, a vaporized liquid carbon source) at the temperature at which carbon is separated from fuel, that is, in a temperature range of 600˜900° C. In the chemical vapor deposition (CVD) method, metal catalytic particles are chiefly used as synthesis intermediates. The chemical vapor deposition (CVD) method includes a conventional CVD method of synthesizing carbon nanotubes by patterning the metal catalytic particles on a substrate, And then supplying the liquid carbon source and the gaseous carbon source thereto, and a thermal pyrolysis method of synthesizing carbon nanotubes by evaporating and atomizing a mixture of the metal catalytic and the liquid carbon source and then directly using the precursor of atomized mixture.

Recently, hot filament plasma enhanced CVD methods, RF plasma enhanced CVD methods, and microwave plasma enhanced CVD methods are actively being researched. As described above, the CVD method, compared to the arc discharge method or laser ablation method, has advantages in that it can be used to grow the carbon nanotubes vertically, synthesize the carbon nanotubes at low temperatures, synthesize the carbon nanotubes at high purity, and synthesize the carbon nanotubes on a large area substrate, and in that the structures of the carbon nanotubes can be easily controlled.

In addition, as a method of synthesizing carbon nanotubes at room-temperature has been developed, various methods of the mass production of carbon nanotubes at low cost have been developed.

Among the CVD methods, the thermal pyrolysis method has advantages in that an additional patterning process is not required, and, since a relatively high temperature energy source is not used in the method, the process itself is simple and the carbon nanotubes can be easily produced in large quantities. Here, not a gaseous carbon source but a liquid carbon source is chiefly used for the growth of carbon nanotubes. In conventional thermal pyrolysis, which uses a liquid carbon source as fuel, carbon nanotubes are synthesized in a reactor by evaporating and atomizing a liquid metal catalyst mixture through a simple heating method. Korean Unexamined Patent Application Publication No. 2002-0025101, laid open on Apr. 3, 2002, entitled “Mass Production Method of Carbon Nanotubes Using a Thermal Pyrolysis Method”, discloses a method of producing carbon nanotubes by evaporating precursors, which are metal catalysts, and additionally injecting hydrocarbons thereto. Furthermore, a thesis entitled “Diamond & Related Materials 14 (2005) 784-789”, discloses a method of synthesizing carbon nanotubes, in which a mixed solution of metal catalyst particles and carbon sources is evaporated through a simple heating method, and is then supplied to a high-temperature reactor, thereby synthesizing carbon nanotubes using a thermal pyrolysis method. However, this method has disadvantages in that the evaporation of metal catalytic particles and carbon sources, having different boiling points from each other, in a vessel can be influenced by the heating condition for evaporation, and in that it is difficult to maintain the amount of precursor constant because the amount of mixture in the vessel changes with the passage of time.

Further, as a method of atomizing the mixed of liquid fuel and metal catalytic particles, recently, an electrospray method and a spray method using a general spray nozzle are being chiefly used. Korean Unexamined Patent Application Publication No. 2002-0009875, laid open on Feb. 2, 2002, entitled “Vapor Phase Synthesis Apparatus for Synthesizing Carbon Nanotubes or Carbon Nanofibers and Method Of Synthesizing the Same Using the Apparatus”, discloses a method of synthesizing carbon nanomaterials in a vertical reactor by injecting the additionally supplied carbon sources and carrier gases into the reactor using a spray method and a spray nozzle. A thesis entitled “Chemical Physics Letters 386, S. R. C. Vivekchand, 2004, 313-318” disclosed a method of synthesizing carbon nanotubes, in which a liquid metal catalyst mixture is evaporated using argon gas in an atomizing apparatus, and then the carbon nanotubes are synthesized using the evaporated mixture. Further, a thesis entitled “Carbon 41, R. Kamalakaran, 2003, 2737-2741” discloses a method of synthesizing carbon nanotubes by injecting a liquid metal catalyst mixture of ferrocene and xylene into a high-temperature reactor through a nozzle having an inner diameter of 0.5 mm. These methods are methods of atomizing liquid droplets using the instantaneous pressure difference in a spray apparatus, and are effective methods in which very small sized droplets can be formed, compared to the simple evaporation method. However, these methods have problems in that the initial investment costs are high because the apparatuses used in these methods are relatively expensive, and in that control systems are complicated.

### SUMMARY OF THE INVENTION

Accordingly, the present invention has been made in order to solve the above problems occurring in the prior art, and an object of the present invention is to provide an apparatus and method for synthesizing carbon nanotubes in which a large amount of carbon nanotubes is uniformly synthesized using only a liquid metal catalyst mixture, composed of liquid carbon sources and metal catalytic particles, without performing an additional patterning process, and in which a large amount of precursors, composed of metal catalytic particles, carbon atoms and hydrogen atoms, is produced at a uniform size by instantaneously evaporating and atomizing a liquid metal catalyst mixture using an ultrasonic vibration method, the operation time and operation intensity of which can be controlled in order to compensate for the problems with the simple heating method and the electrospray method, and thus carbon nanotubes can be synthesized easily and at high efficiency in large quantities using the produced precursors on large area substrates mounted in a reactor through a thermal pyrolysis method while controlling the reaction conditions of the produced precursors.

Another object of the present invention is to provide an apparatus and method for synthesizing carbon nanotubes, in which a large amount of carbon nanotubes is uniformly and continuously synthesized using only a liquid metal catalyst mixture composed of liquid carbon sources and metal catalytic particles without performing an additional patterning process, and in which a large amount of precursors, composed of metal catalytic particles, carbon atoms and hydrogen atoms, is produced at uniform sizes by instantaneously evaporating and atomizing a liquid metal catalyst mixture using an ultrasonic vibration method, the operation time and operation intensity of which can be controlled in order to make up for problems with a simple heating method and an electrospray method, and carbon nanotubes can be synthesized cheaply, at high efficiency, and continuously in large quantities using the produced precursors on large area substrates mounted in a reactor through a thermal pyrolysis method, while controlling the reaction condition of the produced precursors, thereby easily producing the carbon nanotubes using a continuous collection method.

In order to accomplish the above objects, an embodiment according to the present invention provides an apparatus for synthesizing carbon nanotubes using an ultrasonic evaporation method, including: a fuel supply unit for supplying a large amount of liquid metal catalyst mixture using a syringe pump for quantitatively supplying a liquid metal catalyst mixture mixed with hydrocarbon-based liquid carbon sources such as xylene, toluene, benzene and the like, and metal catalytic particles such as iron, nickel, cobalt, molybdenum and the like, and a general liquid pump for supplying a liquid metal catalyst mixture depending on the amount of the liquid metal catalyst mixture; an evaporation unit for evaporating and atomizing the liquid metal catalyst mixture, supplied from the fuel supply unit, into precursors having a uniform size on the nanometer scale; a carrier gas supply unit for transferring precursors atomized in the evaporation unit to a reactor and transferring carrier gas, having an influence on the synthesis of carbon nanotubes, to the reactor; a horizontally oriented reaction unit for the mass production of carbon nanotubes using the carrier gas supplied from the carrier gas supply unit and the precursors formed in the evaporation unit; a filtering unit comprising a filter for filtering residual particles among the atomized particles synthesized into carbon nanotubes in the horizontally oriented reaction unit and some of the carbon nanotubes synthesized in the vapor phase; and a vacuum generation unit comprising a vacuum pump configured to be connected with the filtering unit, decrease the pressure in the reactor, and remove oxygen remaining in the reactor.

Further, another embodiment according to the present invention provides a method of synthesizing carbon nanotubes using an ultrasonic evaporation method, in which the carbon nanotubes having high purity, controlled such that they have quantitatively known and equal sizes, are synthesized on large area substrates in a horizontal state in large quantities, including the steps of providing an apparatus for the mass production of carbon nanotubes using a ultrasonic control method of automatically controlling the operation time and intensity and then quantitatively supplying a liquid metal catalyst mixture, which is a mixture of various liquid carbon sources and metal catalytic particles; producing precursors having a uniform size on the nanometer scale, combined with metal catalytic particles, carbon atoms and hydrogen atoms, in large quantities by instantaneously evaporating and atomizing the supplied liquid metal catalyst mixture using an ultrasonic vibration method of automatically controlling the operation time and intensity; and transferring the atomized precursors having a uniform size on the nanometer scale with carrier gas, pyrolyzing them into carbon atoms, hydrogen atoms and metal catalytic particles in a high-temperature reactor, and then adsorbing and diffusing only the carbon atoms among the pyrolyzed particles using the metal catalytic particles, thereby forming the shape and structure of carbon nanotubes.

The reason for using a general pump is that the capacity of a syringe pump is insufficient in the case where a liquid metal catalyst mixture is supplied in large quantities and thus the scale thereof is increased, thus a pump having a large capacity can be used without difficulty. A simple operational ultrasonic evaporation method is limitedly used in order to be suitable for the amount and kind of the liquid metal catalyst mixture. Therefore, an ultrasonic evaporation system must be used, and must be provided with an automatic control unit capable of controlling time and intensity.

In the step of pyrolysis, the concentration of the metal catalyst, which determines the shape and structure of the carbon nanotubes, is controlled depending on the liquid metal catalyst mixture, in which the metal catalytic particle is mixed with liquid carbon sources to a concentration thereof of 0.1 mol %˜6.5 mol %. Although mentioned in the following examples, the reason for limiting the numerical value described above is that, in a principle of synthesizing carbon nanotubes using the evaporation method of the present invention, when a very small amount of the metal catalytic particles is supplied, the growth rate of the carbon nanotubes can be decreased, and, when a very large amount of the metal catalytic particles is supplied, the purity of the products is influenced by the large amount of metal catalytic particles included in cavity of the carbon nanotubes, and subsequent processes, such as a purification process, etc. become complicated.

Here, any one, or more than one, selected from among hydrocarbon sources such as xylene, toluene, benzene and the like, are used as the liquid carbon sources.

Further, any one, or more than one selected from the group consisting of iron, nickel, cobalt, and molybdenum are used as the metal catalyst particles.

A further embodiment according to the present invention provides an apparatus for synthesizing carbon nanotubes using an ultrasonic evaporation method, including a fuel supply unit for supplying a large amount of liquid metal catalyst mixture using a syringe pump for quantitatively supplying a liquid metal catalyst mixture mixed with hydrocarbon-based liquid carbon sources such as xylene, toluene, benzene and the like, and metal catalytic particles such as iron, nickel, cobalt, molybdenum and the like, and a general liquid pump for supplying a liquid metal catalyst mixture depending on the amount thereof; an evaporation unit for evaporating and atomizing the liquid metal catalyst mixture supplied from the fuel supply unit into precursors having a uniform size on the nanometer scale; a carrier gas supply unit for transferring particles atomized in the evaporation unit to a reactor and transferring carrier gas, which influences the synthesis of carbon nanotubes, to the reactor; a vertically oriented reaction unit for continuously synthesizing carbon nanotubes using the carrier gas supplied from the carrier gas supply unit and the precursors formed in the evaporation unit; a continuous collection unit for continuously collecting residual particles among the atomized particles synthesized into carbon nanotubes in the vertically oriented reaction unit and carbon nanotubes synthesized in the vapor phase; and a vacuum generation unit comprising a sample vessel connected with the continuous collection unit and a vacuum pump for decreasing the pressure in the reactor and removing oxygen remaining in the reactor.

The reason for using a general pump is that the capacity of a syringe pump is insufficient in the case where a liquid metal catalyst mixture is supplied in large quantities and thus the scale thereof is increased, and thus a pump having a large capacity can be used without difficulty. A simple operational ultrasonic evaporation method is limitedly used in order to be suitable for the amount and kind of the liquid metal catalyst mixture. Therefore, an ultrasonic evaporation system must be used, and must be provided with an automatic control unit capable of controlling time and intensity.

The continuous collection unit includes a screw; and a motor control unit configured such that the screw is operated using a motor, and such that the operation speed of the motor is controlled depending on the amount of the produced carbon nanotubes.

Further, a still further embodiment according to the present invention provides a method of synthesizing carbon nanotubes using an ultrasonic evaporation method, in which the carbon nanotubes having high purity, controlled such that they have quantitatively known and uniform sizes, are continuously synthesized in a vertical state using a continuous collection method, including the steps of providing an apparatus for the mass production of carbon nanotubes using an ultrasonic control method of automatically controlling the operation time and intensity and then quantitatively supplying a liquid metal catalyst mixture, which is a mixture of various liquid carbon sources and metal catalytic particles; continuously producing precursors having a uniform size on the nanometer scale, combined with metal catalytic particles, carbon atoms and hydrogen atoms, by instantaneously evaporating and atomizing the supplied liquid metal catalyst mixture using an ultrasonic vibration method of automatically controlling the operation time and intensity; and transferring the atomized precursors having a uniform size on the nanometer scale with carrier gas, pyrolyzing them into carbon atoms, hydrogen atoms and metal catalytic particles in a high-temperature reactor, and then adsorbing and diffusing only the carbon atoms, among the pyrolyzed particles, using the metal catalytic particles, thereby determining the shape and structure of carbon nanotubes.

In the step of pyrolysis, the concentration of the metal catalyst, controlling the shape and structure of the carbon nanotubes, is controlled depending on the liquid metal catalyst mixture, in which the metal catalytic particle is mixed with liquid carbon sources to a concentration thereof of 0.1 mol %˜6.5 mol %. Although mentioned in the following examples, the reason for limiting the numerical value as described above is that, in a principle of synthesizing carbon nanotubes using the evaporation method of the present invention, when a very small amount of metal catalytic particles is supplied, the growth rate of the carbon nanotubes is decreased, and, when a very large amount of metal catalytic particles is supplied, the purity of the products is influenced by the large amount of metal catalytic particles included in cavity of the carbon nanotubes, and subsequent processes, such as a refining process, etc. become complicated.

Here, any one, or more than one selected from hydrocarbon sources such as xylene, toluene, benzene and the like are used as the liquid carbon sources.

Further, any one, or more than one selected from the group consisting of iron, nickel, cobalt, and molybdenum are used as the metal catalyst particles.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a horizontal type system for synthesizing carbon nanotubes using a thermal pyrolysis method by supplying liquid precursors using an ultrasonic evaporation method according to the present invention;

FIG. 2 is a schematic view showing a large area substrate and a process of synthesizing carbon nanotubes using the substrate in the horizontal type system for synthesizing carbon nanotubes using a thermal pyrolysis method by supplying liquid precursors using an ultrasonic evaporation method according to the present invention;

FIG. 3 is a schematic view showing a principle of forming and evaporating a liquid metal catalyst mixture into liquid precursors using an ultrasonic evaporation method according to the present invention;

FIG. 4 is a schematic view showing a principle of synthesizing atomized liquid precursors into carbon nanotubes using a thermal pyrolysis method according to the present invention;

FIG. 5 is a schematic view showing a mechanism for synthesizing carbon nanotubes in a thermal pyrolysis system using an ultrasonic evaporation method according to the present invention;

FIG. 6 is a schematic view showing a vertical type system for synthesizing carbon nanotubes using a thermal pyrolysis method by supplying liquid precursors using an ultrasonic evaporation method according to the present invention;

FIG. 7 is graphs showing an example of the synthesis of carbon nanotubes and the control of the structure thereof depending on the synthesis time in a thermal pyrolysis system using an ultrasonic evaporation method according to the present invention;

FIG. 8 is photographs showing an example of carbon nanotubes synthesized on large area substrates in a horizontally oriented thermal pyrolysis system using an ultrasonic evaporation method according to the present invention;

FIG. 9 is graphs showing an example of the synthesis of carbon nanotubes and the control of the structure thereof depending on reactor temperature in a thermal pyrolysis system using an ultrasonic evaporation method according to the present invention;

FIG. 10 is a graph showing an example of the results of Raman analysis on carbon nanotubes depending on reactor temperature in a thermal pyrolysis system using an ultrasonic evaporation method according to the present invention;

FIG. 11 is a graph showing an example of the synthesis of carbon nanotubes and the control of the structure thereof depending on the concentration of metal catalytic particles in a thermal pyrolysis system using an ultrasonic evaporation method according to the present invention;

FIG. 12 is SEM analysis photographs showing an example of the dependence of the shape of the synthesized carbon nanotubes on the synthesis location thereof in a thermal pyrolysis system using an ultrasonic evaporation method according to the present invention;

FIG. 13 is SEM and TEM analysis photographs showing an example of the structure of the synthesized carbon nanotubes in a thermal pyrolysis system using an ultrasonic evaporation method according to the present invention;

FIG. 14 is SEM analysis photographs showing an example of the growth distribution of the continuously synthesized carbon nanotubes in a vertically oriented thermal pyrolysis system using an ultrasonic evaporation method according to the present invention;

FIG. 15 is a TEM analysis photograph showing an example of the shape and structure of the continuously synthesized carbon nanotubes in a vertically oriented thermal pyrolysis system using an ultrasonic evaporation method according to the present invention;

FIG. 16 is a TGA analysis graph showing an example of the purity of the continuously synthesized carbon nanotubes in a vertically oriented thermal pyrolysis system using an ultrasonic evaporation method according to the present invention;

FIG. 17 is a graph showing an example of the maximum evaporation rate of a liquid metal catalyst mixture depending on the power consumption of an ultrasonic evaporation control unit in a thermal pyrolysis system using an ultrasonic evaporation method according to the present invention; and

FIG. 18 is a photograph showing an example of the shape of the evaporated liquid metal catalyst mixture depending on the power consumption, when benzene and ferrocene are used as the liquid metal catalyst mixture and evaporated, in a thermal pyrolysis system using an ultrasonic evaporation method according to the present invention.

### DESCRIPTION OF THE PREFERRED EMBODIMENTS

Hereinafter, preferred embodiments of the present invention will be described in detail with reference to the attached drawings.

Reference now should be made to the drawings, in which the same reference numerals are used throughout the different drawings to designate the same or similar components.

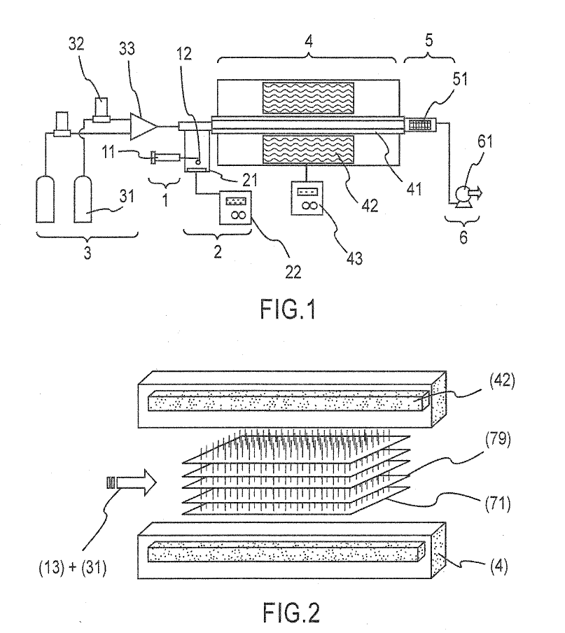

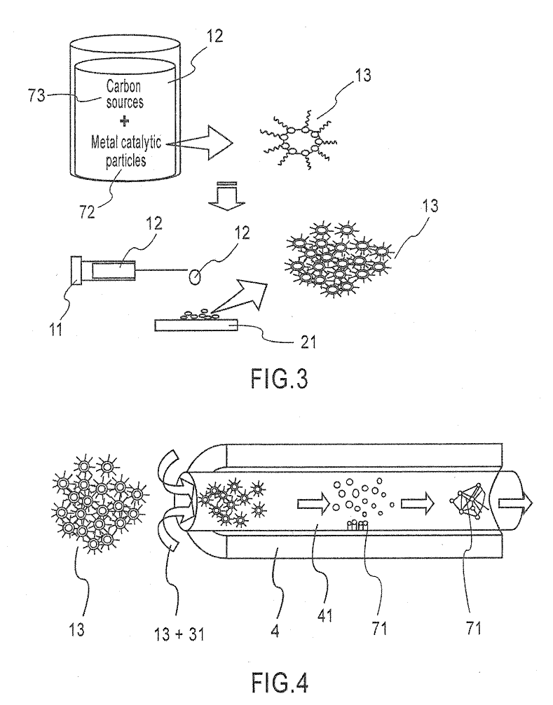

FIG. 1 is a schematic view showing a horizontal type system for synthesizing carbon nanotubes using a thermal pyrolysis method by supplying liquid precursors using an ultrasonic evaporation method according to the present invention, and FIG. 3 is a schematic view showing a principle of forming and evaporating a liquid metal catalyst mixture into liquid precursors using an ultrasonic evaporation method according to the present invention. As shown in FIGS. 1 and 3, a fuel supply unit 1 of the present invention is provided with a syringe pump 11 in order to quantitatively supply a liquid metal catalyst mixture 12 including various liquid carbon sources and various metal catalytic particles. Here, the liquid metal catalyst mixture 12 is quantitatively supplied through the syringe pump 11. In this case, even if the quantitatively supplied amount of the liquid metal catalyst mixture 12 is increased by using a general pump in place of the syringe pump 11, the increase in the amount thereof has no effect on the operation of the system for synthesizing carbon nanotubes.

The reason for using a general pump in place of the syringe pump 11 is that the capacity of the syringe pump is insufficient in the case where the liquid metal catalyst mixture is supplied in large quantities, and thus a general quantitative pump can be used in place of the syringe pump 11. In this case, an ultrasonic evaporation method, operated by simple ON/OFF control, can be limitedly used. Therefore, the system capable of controlling time and intensity according to the invention can correspond to the amount and kind of the liquid metal catalyst mixture.

A mixture including liquid carbon sources 73, which are hydrocarbon fuels such as xylene, benzene, toluene and the like, and metal catalytic particles 72 such as iron, nickel, cobalt and the like, is chiefly used as the liquid metal catalyst mixture 12.

The liquid metal catalyst mixture 12 is a mixed form in which carbon and hydrogen are bound to each of metal catalytic particles. In the present invention, the liquid metal catalyst mixture 12 is supplied to an evaporation unit 2 through a syringe pump 11 in the form of droplets, and then evaporated and atomized therein. Depending on the amount of the liquid metal catalyst mixture 12, the liquid metal catalyst mixture 12 may be continuously supplied to the evaporation unit 2 using a quantitative liquid pump in place of the syringe pump 11.

The droplets, supplied through the syringe pump 11 in the fuel supply unit 1, are dropped on an ultrasonic vibration plate, and are simultaneously atomized into very small particles having a size on the nanometer scale. This particle is a kind of precursor 13. The precursor 13 has a form of combining carbon and hydrogen with metal catalytic particle. The atomized precursor 13 is a very small particle having a size on the nanometer scale.

The ultrasonic vibration plate 21 is separately controlled by an additional ultrasonic evaporator control unit 22. Further, the ultrasonic vibration plate 21 is controlled such that it is not operated when the liquid droplets of the liquid metal catalyst mixture 12 are not dropped thereon, and such that it is operated when the liquid droplets thereof are dropped thereon, so as to atomize the liquid droplets thereof by vibrating them very rapidly. The reason for controlling the ultrasonic vibration plate 21 as above is that, when the ultrasonic vibration plate 21 is operated even if the liquid metal catalyst mixture 12 has been not supplied to the ultrasonic vibration plate 21 for a long time, it works too hard and thus breaks down. To ensure this, the ultrasonic vibration plate 21 is automatically controlled by the ultrasonic evaporator control unit 22 such that, when the liquid droplets are continuously supplied, the ultrasonic vibration plate 21 is also continuously operated, and, when the amount of the liquid metal catalyst mixture 12 is varied, the vibration intensity of the ultrasonic waves is also varied. The operation time of the ultrasonic vibration plate 21, depending on the variation in the supplied amount of the liquid metal catalyst mixture 12, is controlled such that the operation time of an ON/OFF timer is coordinated with the variation in the supplied amount in the fuel supply unit 1, and the operation intensity of the ultrasonic vibration plate 21 is controlled by converting the variation in the amount thereof into an increase in the voltage supplied to the ultrasonic vibration plate 21, that is, by varying power consumption.

The atomized precursors 13 are transferred to a reactor by carrier gas 31 supplied from the exterior. A mixed gas including argon gas and hydrogen gas is used as the carrier gas 31. The mixed gas includes about 10 vol % of hydrogen gas.

The reason that the carrier gas includes hydrogen gas is that the growth mechanism and structural characteristics of carbon nanotubes can be influenced by the amount of hydrogen. Therefore, the amount of hydrogen is controlled depending on each unit, or on the characteristics of the carbon nanotubes. In the present invention, when the carrier gas includes 10 vol % of hydrogen gas, carbon nanotubes having the highest quality are synthesized.

Further, argon gas is used as a reduction gas for forming a reducing atmosphere (oxygen-free atmosphere) in the interior of the reactor.

Since argon gas is heavier than nitrogen gas or helium gas, it helps to stably synthesize carbon nanotubes.

The carrier gas 31 is controlled by a flow control unit 32. The carrier gas 31 is uniformly mixed in a mixing unit 33, and is then transferred to the evaporation unit 2.

The carrier gas 31 transfers precursors 13 to a reaction unit 4, maintained at a temperature of 600˜900° C.

The reaction unit 4 includes a quartz tube 41 in which the carrier gas reacts with the precursors, a heater 42, which surrounds the quartz tube 41 and heats it, and a reactor temperature control unit 43, which control the temperature of the heater 42.

The quartz tube 41 is composed of a material which can be used at a maximum temperature of 1500° C. The reactor is designed to raise an internal temperature thereof to a maximum temperature of 1500° C.

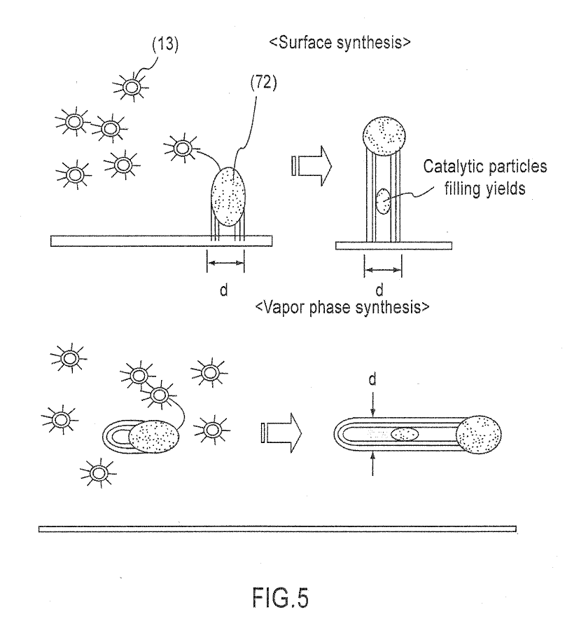

FIG. 4 is a schematic view showing a principle of synthesizing atomized liquid precursors into carbon nanotubes using a thermal pyrolysis method according to the present invention, and FIG. 5 is a schematic view showing a mechanism for synthesizing carbon nanotubes in a thermal pyrolysis system using an ultrasonic evaporation method according to the present invention. As shown in FIGS. 4 and 5, the transferred precursor 13 has a structure in which carbon and hydrogen are combined with a metal catalytic particle 72. When the precursor having the structure reaches the reactor, maintained at a temperature of 600˜900° C., carbon and hydrogen are separated from the precursor. Among the separated carbon and hydrogen, the hydrogen is removed, and the carbon is adsorbed on the metal catalytic particle 72.

The adsorbed carbon is diffused from the metal catalytic particle 72, thereby forming a graphite surface. The formed graphite is synthesized into a carbon nanotube 71, that is, the shape thereof becomes a tubular shape. In this case, the synthesized carbon nanotube 71 grows while remaining an end thereof open due to the separation of hydrogen, new metal catalytic particles 72 are introduced into the open carbon nanotube 71, and this phenomenon is repeated, thereby rapidly growing the carbon nanotube 71. Finally, when supply of the carbon and metal catalytic particles is stop, the end of the carbon nanotube 71 is covered by the graphite surface, thereby terminating the growth of the carbon nanotube 71.

The synthesized carbon nanotube 71 is vertically grown on the surface of the quartz tube. In this case, the carbon nanotube 71, synthesized on the surface of the metal catalytic particle 72 having a relatively small size, is synthesized in a vapor phase, according to the mechanism which is observed in the filter 51 shown in FIG. 1.

Further, if oxygen flow into the reactor, carbon included in the liquid metal catalyst mixture burns, and thus inhibits the synthesis of the carbon nanotube 71. Accordingly, a vacuum pump 61 is placed behind the filter 51 shown in FIG. 1 in order to maintain the atmosphere in the reactor to a reducing atmosphere, thereby providing a suitable controlled atmosphere and inner pressure.

In the controlled atmosphere, before the synthesis of carbon nanotubes, a reducing atmosphere is controlled by argon gas in order to remove oxygen in the reactor, and, in the step of synthesizing carbon nanotubes, the interior of the reactor is controlled by the hydrogen, generated by pyrolyzing the evaporated carbon sources and the argon gas. The inner pressure in the reactor is maintained at a pressure of about 2×10⁻³ torr.

FIG. 2 is a schematic view showing the arrangement of large area substrates 79 suitable for synthesizing carbon nanotubes 71 in large quantities and the process of synthesizing carbon nanotubes 71 in the horizontal type reaction method described above. As shown in FIG. 2, the precursors supplied by carrier gas 31 are deposited on the large area substrate 79, and are grown into carbon nanotubes 71 while graphite sheet is diffused using the substrates 79 as supports. The large area substrates 79 can be arranged in any of horizontal and vertical orientations.

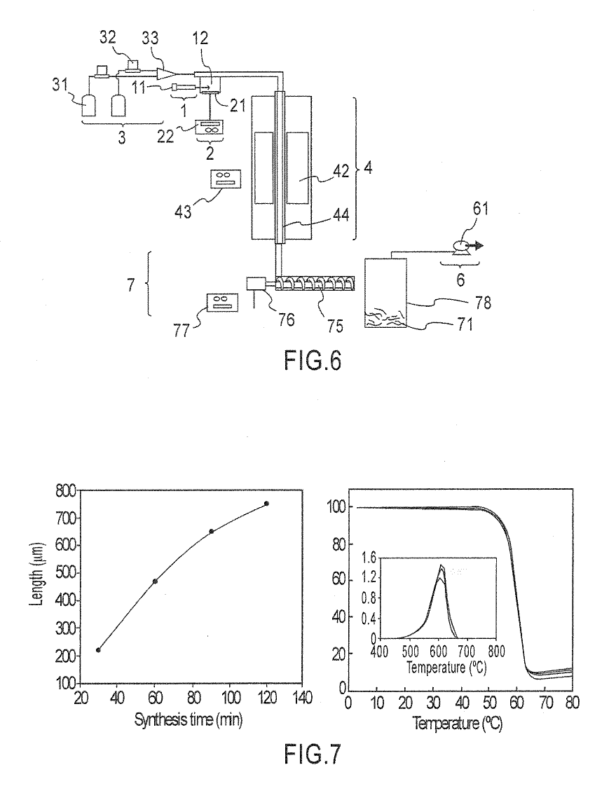

FIG. 6 is a schematic view showing a vertical type system for synthesizing carbon nanotubes 71 using a thermal pyrolysis method by supplying liquid precursors using an ultrasonic evaporation method according to the present invention.

As shown in FIG. 6, the system for synthesizing carbon nanotubes 71 includes a fuel supply unit 1, an evaporation unit 2, and a carrier gas supply unit 3, which are included in the system for synthesizing carbon nanotubes 71 shown in FIG. 1. In addition, the system for synthesizing carbon nanotubes 71 further includes a vertically oriented reaction unit 4 for continuously synthesizing carbon nanotubes 71 using the carrier gas supplied from the carrier gas supply unit 3 and the precursors formed in the evaporation unit 2; a continuous collection unit 7 for continuously collecting residual particles from among the atomized particles synthesized into carbon nanotubes 71 in the vertically oriented reaction unit 4 and carbon nanotubes 71 synthesized mainly in the vapor phase; and a vacuum generation unit 6 connected with the continuous collection unit 7, including a vacuum pump 61 for decreasing the pressure in the reactor and removing oxygen remaining in the reactor.

The vertically oriented reaction unit 4 includes a tube 44, in which the carrier gas reacts with the precursors, a heater 42 which surrounds the tube 44 and heats it, and a reactor temperature control unit 43 which control the temperature of the heater 42.

The tube 44 is composed of ceramic, which is a material other than quartz, which can be used at a maximum temperature of 1200° C. The temperature of the reactor can be raised to a maximum temperature of 1200° C.

The continuous collection unit 7 is provided therein with a screw 75, and the screw 75 is operated by a motor 76. Further, the continuous collection unit 7 is provided with an additional motor control unit 77 such that the operation speed of the screw 75 is controlled depending on the amount of produced carbon nanotubes 71. The process of synthesizing the carbon nanotubes 71 is completed by finally collecting the carbon nanotubes discharged through the screw 75 in a sample vessel 78.

As described above, in the present invention, the reaction unit may be configured to produce the carbon nanotubes in large quantities according to the respective characteristics thereof, as shown in FIGS. 1 and 6.

That is, when the reaction unit having a horizontally oriented structure shown in FIG. 1 is used, it is preferred that the carbon nanotubes be produced in large quantities using the large area substrates 79, and, when the reaction unit having a vertically oriented structure shown in FIG. 6 is used, it is preferred that the carbon nanotubes be continuously produced by continuously collecting the synthesized carbon nanotubes 71 using the continuous collection unit 7.

Hereinafter, preferred Examples of the present invention will be described in detail.

### Example 1

An apparatus for synthesizing carbon nanotubes was disposed as shown in FIG. 1, and then an experiment thereon was carried out as shown in FIG. 7. FIG. 7 is graphs showing an example of the synthesis of carbon nanotubes and the control of the structure thereof depending on the synthesis time in a thermal pyrolysis system using an ultrasonic evaporation method according to the present invention.

The experiment was carried out under the condition that the reaction unit 4, shown in FIG. 1, was maintained at a temperature of 850° C., the concentrations of metal catalytic particles 72 included in liquid carbon sources 73 were 6.5 mol % in all experiments, the supply rate of the liquid metal catalyst mixture 12 was maintained at a rate of 5 ml/hr through a syringe pump 11, and the synthesis times of the carbon nanotubes 71 were 30 min, 60 min, 90 min and 120 min, respectively. The results of the experiments are shown in FIG. 7. The liquid metal catalyst mixture 12 supplied through the syringe pump 11 is induced through a needle. Here, when the liquid metal catalyst mixture 12 is supplied to the needle having a diameter of 1 mm at a rate of 5 ml/hr, there is a problem in that, since droplets of the liquid metal catalyst mixture 12 are not continuously dropped on a vibration plate, but are dropped thereon at intervals, apparatuses can be damaged by being operated excessively in the case in which the vibration plate is continuously operated. Accordingly, in Example 1, the operation time of the vibration plate was controlled such that the operation of the vibration plate is automatically turned ON/OFF depending on the supply rate of the droplets. In this experiment, the vibration plate was automatically controlled such that it is OFF for 2 sec, and ON for 5 sec. Further, maximum power consumption was 0.5 W at the time of operation.

The diameters of the synthesized carbon nanotubes were similar to each other, but the lengths of the grown carbon nanotubes were 220 μm, 480 μm, 650 μm, and 750 μm, respectively, therefore, it was found that the lengths of as-grown carbon nanotubes increased with the passage of time. The growth rates of the carbon nanotubes were 7.3 μm/min, 8.0 μm/min, 7.2 μm/min, and 6.2 μm/min, respectively. Accordingly, it was found that the growth rates of the carbon nanotubes increased up to 60 min whereas it decreased after 60 min.

The above results were also confirmed in a TGA graph. That is, it was found that, as the result of evaluating samples obtained by carrying out experiments under the condition that the liquid metal catalyst mixture includes metal catalytic particles having the same concentration and the synthesis times of carbon nanotubes are different from each other, the amount of carbon nanotubes 71 included in products increased with the increase in the synthesis time. That is, it was found that the carbon nanotubes 71, grown under the condition of a long synthesis time, were longer than the carbon nanotubes 71 grown under other conditions.

### Example 2

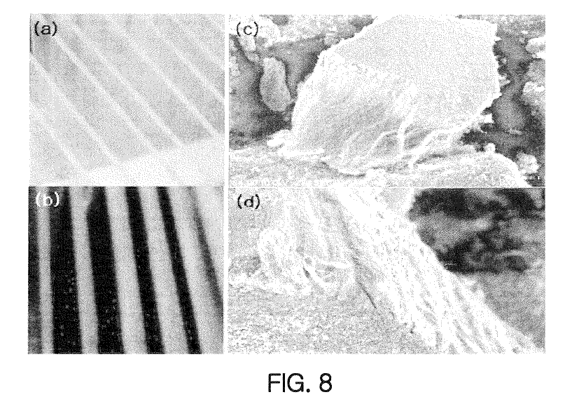

An apparatus for synthesizing carbon nanotubes was disposed as shown in FIGS. 1 and 2, and then an experiment thereon was carried out as shown in FIG. 8. The experiment was carried out under the condition that the temperature in the reaction unit 4, shown in FIG. 1, was maintained at a temperature of 800° C., the concentrations of metal catalytic particles 72 included in liquid carbon sources 73 were 6.5 mol % in experiments, the supply rate of a liquid metal catalyst mixture 12 was maintained at a rate of 500 ml/hr through a general quantitative pump without using a syringe pump 11, and the synthesis time of the carbon nanotubes 71 was 30 min. The results of the experiments are shown in FIG. 8. Since the liquid metal catalyst mixture 12 supplied through the general quantitative pump was supplied through a tube having a diameter of 1/16 inches and was then continuously supplied to a vibration plate, the vibration plate was continuously operated in an ON state. Maximum power consumption was 40 W at the time of operation. In this experiment, ten quartz plates having a height of 20 cm and a length of 60 cm were arranged parallel to each other at intervals of 1 cm, thereby constituting large area substrates 79. FIG. 8A shows large area substrates 79 before the experiment, and FIG. 8B shows the carbon nanotubes 71 synthesized on the substrates 79 after the experiment. FIGS. 8C and 8D show the shape and structure of the synthesized carbon nanotubes 71, determined by measuring the synthesized carbon nanotubes 71 using a SEM. As shown in FIGS. 8C and 8D, the synthesized carbon nanotubes 71 were vertically grown in a well-arranged state, and showed a congregated form, like a carpet. Further, it was found that the carbon nanotubes have an average size of about 50˜70 nm, and are multi-walled carbon nanotubes.

### Example 3

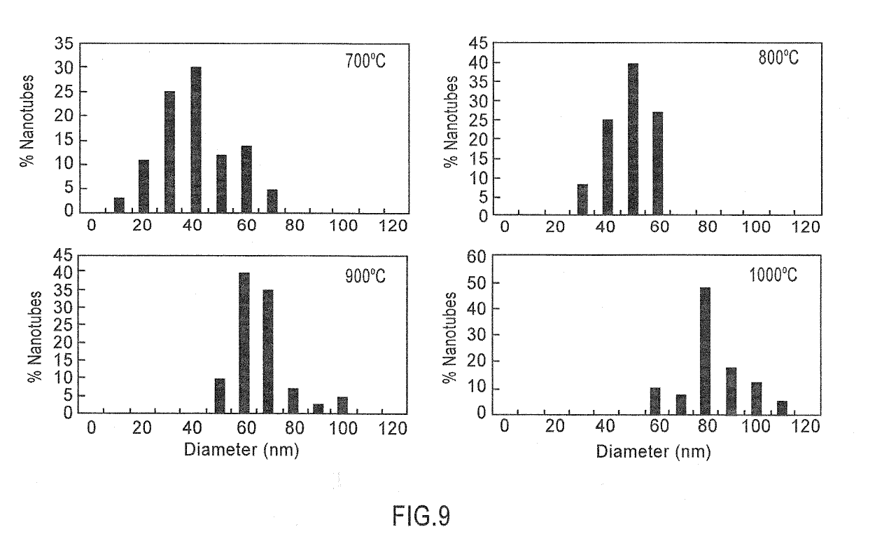

An apparatus for synthesizing carbon nanotubes was disposed as shown in FIG. 1, and then an experiment thereon was carried out as shown in FIG. 9. FIG. 9 is graphs showing an example of the synthesis of carbon nanotubes and the control of the structure thereof depending on reactor temperature in a thermal pyrolysis system using an ultrasonic evaporation method according to the present invention. As shown in FIG. 9, the average diameters of samples were evaluated according to the experimental results measured under the condition that the temperatures of reaction unit 4, shown in FIG. 1, were 700° C., 800° C., 900° C. and 1000° C., respectively.

The carbon nanotubes 71 were grown under the condition that the concentrations of metal catalyst particles 72 included in liquid carbon sources 73 were 6.5 mol % in all experiments, the supply rate of the liquid metal catalyst mixture 12 was maintained at a rate of 5 ml/hr using a syringe pump 11, and the synthesis time of the carbon nanotubes 71 was 60 min. The operation time and power consumption of the vibration plate are the same as that in Example 1.

As a result, it was found that the average diameters of the synthesized carbon nanotubes 71 were increased with the increase of the synthesis temperature. Here, the average diameters of the synthesized carbon nanotubes 71 were 30˜40 nm at a temperature of 700° C., 45˜55 nm at a temperature of 800° C., 65 nm at a temperature of 900° C., and 80 nm at a temperature of 1000° C., respectively.

### Example 4

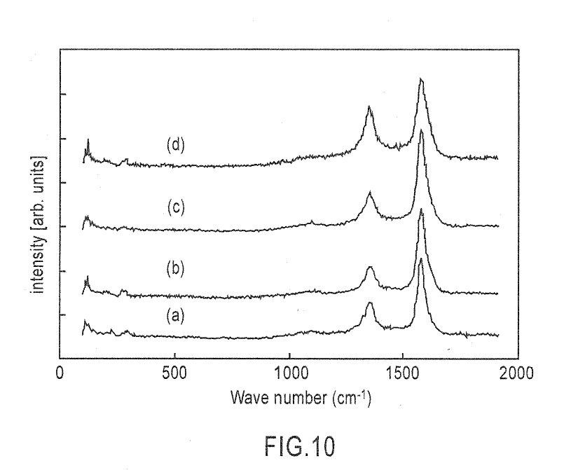

FIG. 10 is a graph showing an example of the results of Raman analysis on carbon nanotubes depending on reactor temperature in a thermal pyrolysis system using an ultrasonic evaporation method according to the present invention. As shown in FIG. 10, the results of Raman analysis on carbon nanotubes were evaluated according to the experimental results measured under the condition that the temperatures of reaction unit 4, shown in FIG. 1, are 700° C., 800° C., 900° C. and 1000° C., respectively.

Generally, the Raman analysis for carbon is characterized in that G-line (Graphite pick) is observed at a wave number of about 1580 cm⁻¹, and D-line (Disordered pick) is observed at a wave number of about 1350 cm⁻¹. The results were also the same in the case of the nanotubes synthesized in the present invention. In particular, it was observed that the value of G-line, indicating carbon nanotubes having good structures, was very high in most experiments. Further, it was found that the intensity ratio of the D-line to the G-line was highest at a temperature of 800˜900° C. Accordingly, it was found that carbon nanotubes 71 having the best crystalline structure could be synthesized at the above temperature range.

### Example 5

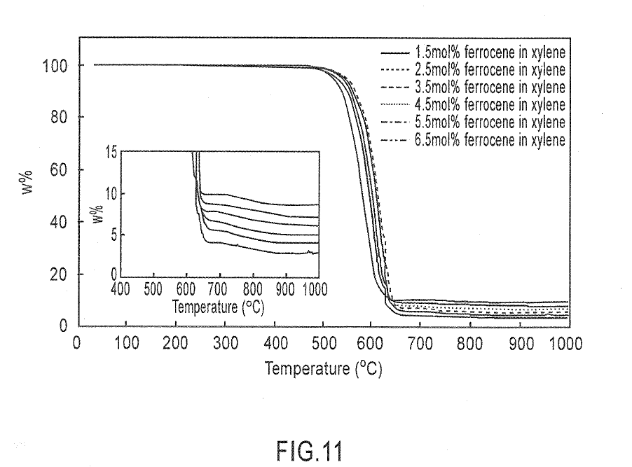

An apparatus for synthesizing carbon nanotubes was disposed as shown in FIG. 1, and then an experiment thereon was carried out as shown in FIG. 11. FIG. 11 is a graph showing an example of the synthesis of carbon nanotubes and the control of the structure thereof depending on the concentration of metal catalytic particles in a thermal pyrolysis system using an ultrasonic evaporation method according to the present invention.

The experiment was carried out under the condition that the reaction unit 4, shown in FIG. 1, was maintained at a temperature of 850° C. The carbon nanotubes 71 were grown under the condition that the concentrations of the metal catalytic particles 72 included in the liquid carbon sources 73 were changed from 1.5 mol % to 6.5 mol % in increments of 1.0 mol %, the supply rate of the liquid metal catalyst mixture 12 was maintained at a rate of 5 ml/hr using a syringe pump 11, and the synthesis time of the carbon nanotubes 71 was 60 min. The operation time and power consumption of the vibration plate were the same as that in Example 1.

It was found in the TGA graph that, as the concentration of the metal catalytic particles 72 included in the liquid metal catalyst mixture is increased, catalytic particles included in samples having the same weight remained in greater amounts.

Here, it can be seen, based on the experimental results in FIG. 9, that the diameter of the carbon nanotubes 71 synthesized at the same temperature can be maintained constant and that, in the growth mechanism of the carbon nanotubes 71 synthesized according to the present invention, the diameter of the synthesized carbon nanotubes depends on the size of the catalytic particles 72. For this reason, the fact that respective carbon nanotubes 71 having the same diameter include different numbers of metal catalytic particles 72 disproves the fact that the metal catalytic particles 72 having various shapes are included in the carbon nanotubes 71. Accordingly, it was found that, as the concentration of the metal catalytic particles 72 included in the liquid metal catalyst mixture was increased, the number of the metal catalytic particles 72 was increased. That is, it could be seen that, as the amount of the metal catalytic particles 72 included in the liquid metal catalyst mixture provided to synthesize the carbon nanotubes 71 was increased, the carbon nanotubes 71 could include many metal catalytic particles 72 as filling yields (shape of metal catalytic particles included in cavity of carbon nanotubes) in the synthesis step.

### Example 6

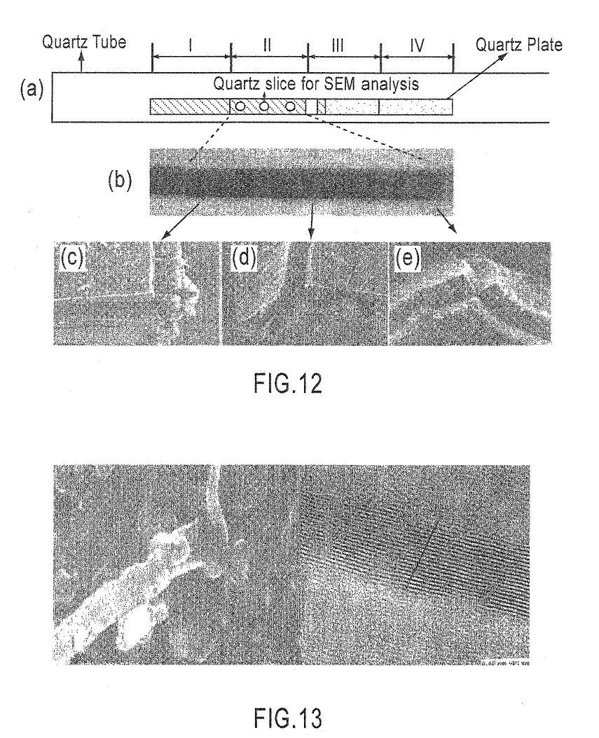

FIG. 12 is SEM analysis photographs showing an example of the dependence of the shape of the synthesized carbon nanotubes on the synthesis location thereof in a thermal pyrolysis system using an ultrasonic evaporation method according to the present invention.

In Example 6, in order to precisely observe the synthesized carbon nanotubes, four quartz plates having a size of 20 mm×150 mm×2 mm were placed on a quartz tube 41, and then three quartz slices having a size of about 10 mm×10 mm×2 mm were on each of the quartz plates. FIG. 12A shows a reactor 4 having the above arrangement, and FIG. 12B shows carbon nanotubes 71 synthesized on the quartz plates. In FIG. 12, it could be seen that carbon nanotubes 71 were uniformly grown on the entire area of the quartz plate. FIG. 12C show the results of SEM-analyzing quartz slices placed on the quartz plate continuously synthesized as above. As shown in FIG. 12C, it can be seen that carbon nanotubes 71 were vertically synthesized over the entire surface exposed to the quartz slices. Further, it can be seen that the synthesized carbon nanotubes 71 have a well-aligned carpet-like arrangement, and that they are pure carbon nanotubes having no impurities.

### Example 7

FIG. 13 is SEM and TEM analysis photographs showing an example of the structure of the synthesized carbon nanotubes in a thermal pyrolysis system using an ultrasonic evaporation method according to the present invention.

From the result of the analysis of an SEM photograph, it was found that carbon nanotubes 71 were attached on the surface of quartz, and were vertically grown. As shown in FIG. 13, it is observed that the average diameter of the carbon nanotubes is about 40˜50 nm. Further, metal catalysts (carbon nano onions), which are not synthesized into nanotubes but encapsulated by graphite sheet, are observed around the roots of the carbon nanotubes 71. That is, it can be seen that, first, metal catalytic particles 72 are dropped on the surface of quartz, and the supplied carbon sources are repeatedly adsorbed and diffused using the metal catalytic particles as intermediates, thereby forming carbon nanotubes. Further, high magnification image of for carbon nanotube walls was shown by TEM images. As shown in FIG. 13, it was found that multiple walls having about twenty graphite shells were formed.

### Example 8

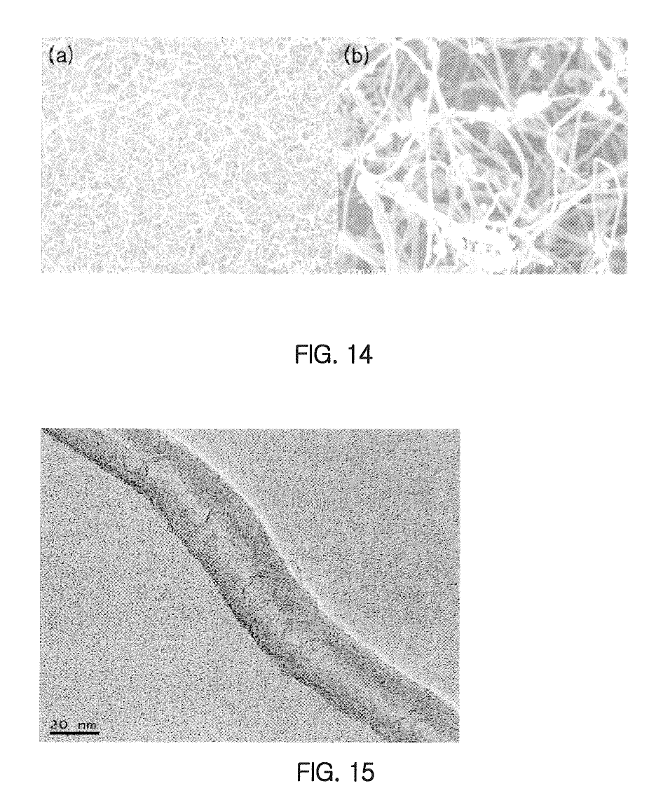

An apparatus for synthesizing carbon nanotubes was disposed as shown in FIG. 6, and then an experiment thereon was carried out as shown in FIG. 14. FIG. 14 is SEM analysis photographs showing an example of the growth distribution of the continuously synthesized carbon nanotubes in a vertically oriented thermal pyrolysis system using an ultrasonic evaporation method according to the present invention. Here, the temperature of a reaction unit 4, shown in FIG. 6, was maintained at a temperature of 800° C., the supply rate of a mixture of carbon sources 73 and metal catalytic particles 72 was maintained at a rate of 5 ml/hr, and the mixture was grown for 60 min. The operation time and power consumption of a vibration plate were the same as that in Example 1. The concentration of metal catalyst particles 72 was set to 3.5 mol %. The moving speed of a screw was set to 30 rpm. It was found that the synthesized carbon nanotubes 71 were relatively clean, the average diameter thereof was 30 nm, and that some of the synthesized carbon nanotubes had a diameter of 50 nm. In view of these results, it can be seen that the carbon nanotubes synthesized under these conditions were slightly thinner than the carbon nanotubes vertically synthesized at the same temperature. Further, it was found that the synthesized carbon nanotubes have curved shapes, unlike the shape of carpet well arranged on the surface of quartz, shown in horizontally oriented structure, so that they were very irregularly grown.

### Example 9

An apparatus for synthesizing carbon nanotubes was disposed as shown in FIG. 6, and then an experiment thereon was carried out as shown in FIG. 14. FIG. 15 is a TEM analysis photograph showing an example of the shape and structure of the continuously synthesized carbon nanotubes in a vertically oriented thermal pyrolysis system using an ultrasonic evaporation method according to the present invention.

The products appear to have uniform diameters. The average diameter of the products was about 30˜40 nm, similar to that determined in the SEM analysis. Further, since the central portions of the products are hollow, it was deduced that the products are nanotubes, and that the walls thereof were surrounded by several graphite shells. Particularly, it was found that structures like thin films were formed in the central portions of the products. Probably, it is likely that the structures are formed by the movement of metal catalytic particles 72.

### Example 10

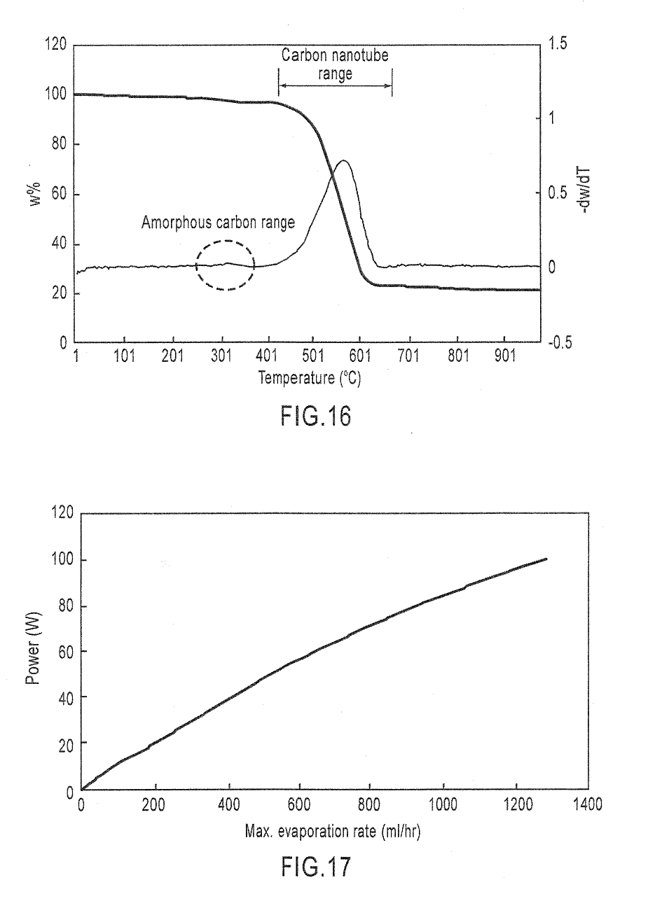

An apparatus for synthesizing carbon nanotubes was disposed as shown in FIG. 6, and then an experiment thereon was carried out as shown in FIG. 14. FIG. 16 is a TGA analysis graph showing an example of the purity of the continuously synthesized carbon nanotubes in a vertically oriented thermal pyrolysis system using an ultrasonic evaporation method according to the present invention. In FIG. 16, the results of analysis of the purity using TGA and differential values are shown. Here, the synthesis temperature of carbon nanotubes was 800° C., the supply rate of a mixture of carbon sources and metal catalyst particles was maintained at a rate of 5 ml/hr, and the mixture was grown for 30 min. The operation time and power consumption of a vibration plate were the same as that in Example 1. The concentration of the metal catalytic particle 72 was set to 6.5 mol %. The moving speed of a screw was set to 30 rpm. As a result, it was found that the synthesized carbon nanotubes 71 had a purity of about 80˜85%. It was predicted that materials other than the carbon nanotubes were metal catalytic particles 72 included in products. Further, it was found that the a small amount of amorphous carbon, which could be found at a temperature of about 350˜400° C., was detected. It was found from differential values of FIG. 16 that the perfect oxidation temperature of the carbon nanotubes was in the range of 500˜700° C.

### Example 11

An apparatus for synthesizing carbon nanotubes was disposed as shown in FIG. 1 or 6, and then an experiment thereon was carried out. FIG. 17 is a graph showing an example of the maximum evaporation rate of a liquid metal catalyst mixture 12 depending on the power consumption of an ultrasonic evaporation control unit in a thermal pyrolysis system using an ultrasonic evaporation method according to the present invention. Here, the ratio of the power consumption to the maximum flow rate of the evaporated metal catalytic particles was measured to be about 0.1˜0.085 W/(ml/hr). Particularly, when the maximum evaporation flow rate was below 20 ml/hr, since the quantity of flow supplied from a syringe needle of 1˜1.5 mm to a vibration plate was not continuous, the operation time of the vibration plate must be controlled. That is, the voltage applied to the vibration plate was automatically turned ON/OFF, and the ON/OFF time was varied. However, the average power consumption was measured in consideration of the actual operating time.

### Example 12

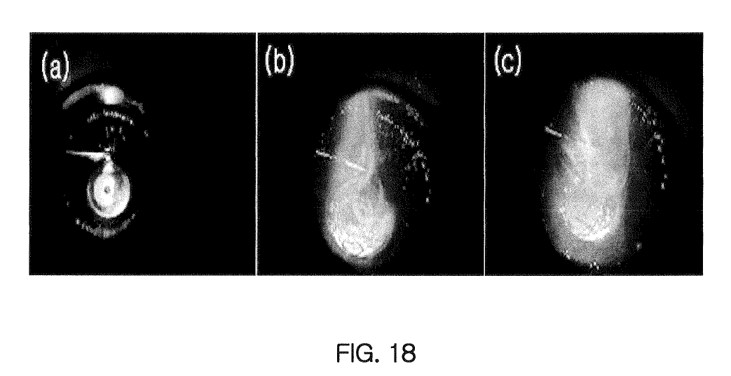

FIG. 18 is a photograph showing the shape of the evaporated liquid metal catalyst mixture depending on the power consumption based on the evaporation principle shown in FIG. 3, when benzene and ferrocene are used as the liquid metal catalyst mixture and evaporated, in a thermal pyrolysis system using an ultrasonic evaporation method according to an example of the present invention. Here, a liquid metal catalyst mixture 12 is supplied at a flow rate of 5 ml/hr through a syringe pump. The concentration of ferrocene included in benzene was 3.5 mol %. FIG. 18A shows the shape of a vibration plate in the case where a controller is an OFF state, and FIGS. 18B and 18C show the shape of the liquid metal catalyst mixture evaporated on the vibration plate in the case where a controller is an ON state. In this experiment, first, the experiment was carried out by supplying power corresponding to power consumption of 0.5 W to a control unit (FIG. 18B). Next, the experiment was carried out by supplying power corresponding to increased power consumption of 1 W to a control unit (FIG. 18B). As the result thereof, it was found that the amount of the evaporated liquid metal catalyst mixture was increased.

As described above, the present invention provides a method of synthesizing carbon nanotubes using liquid carbons sources and metal catalytic particles through thermal pyrolysis. According to the present invention, since a liquid metal catalyst mixture composed of metal catalytic particles and liquid carbon sources is instantaneously atomized using an ultrasonic evaporation method and is then transferred to a high-temperature reactor, a constant amount of precursors can be supplied, and thus quantitative control is possible, carbon nanotubes having uniform sizes can be synthesized, and it is possible to easily control the shape of carbon nanotubes, such as length, diameter, etc.

Further, according to the present invention, since an additional patterning process is not required, carbon nanotubes are easily synthesized in large quantities, and since an ultrasonic evaporation method is precise, cheap and easily controllable compared to a conventional simple heating method and an electrospray method, cheap carbon nanotubes having high purity can be synthesized at high efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of synthesizing carbon nanotubes using an ultrasonic evaporation method, in which the carbon nanotubes, having high purity, controlled such that they have quantitatively known and uniform sizes, are synthesized on large area substrates in a horizontal orientation in large quantities, comprising steps of:
providing an apparatus for synthesizing carbon nanotubes in large quantities using a ultrasonic control method of automatically controlling operation time and intensity and then quantitatively supplying a liquid metal catalyst mixture, which is a mixture of various liquid carbon sources and metal catalytic particles;
producing precursors having a uniform nanometer size, combined with metal catalytic particles, carbon atoms and hydrogen atoms, in large quantities by instantaneously evaporating and atomizing the supplied liquid metal catalyst mixture using an ultrasonic vibration method of automatically controlling operation time and intensity; and
transferring the atomized precursors having a uniform nanometer size with carrier gas, pyrolyzing them into carbon atoms, hydrogen atoms and metal catalytic particles in a high-temperature reactor, and then adsorbing and diffusing only the carbon atoms among the pyrolyzed particles using the metal catalytic particles, thereby forming the shape and structure of carbon nanotubes.

2. A method of synthesizing carbon nanotubes using an ultrasonic evaporation method, in which the carbon nanotubes having high purity, controlled such that they have quantitatively known and uniform sizes, are continuously synthesized in a vertical state using a continuous collection method, comprising steps of:
providing an apparatus for synthesizing carbon nanotubes in large quantities using an ultrasonic control method of automatically controlling operation time and intensity and then quantitatively supplying a liquid metal catalyst mixture, which is a mixture of various liquid carbon sources and metal catalytic particles;
continuously producing precursors having a uniform nanometer size, combined with metal catalytic particles, carbon atoms and hydrogen atoms, by instantaneously evaporating and atomizing the supplied liquid metal catalyst mixture using an ultrasonic vibration method of automatically controlling operation time and intensity; and
transferring the atomized precursors having a uniform manometer size with carrier gas, pyrolyzing them into carbon atoms, hydrogen atoms and metal catalyst catalytic in a high-temperature reactor, and then adsorbing and diffusing only the carbon atoms among the pyrolyzed particles using the metal catalytic particles, thereby determining a shape and structure of carbon nanotubes.

3. The method according to claim 1 or 2, wherein, in the step of pyrolysis, the concentration of the metal catalyst, determining the shape and structure of the carbon nanotubes, is controlled depending on the liquid metal catalyst mixture, in which the metal catalytic particle is mixed with liquid carbon sources to a concentration thereof of 0.1 mol %˜6.5 mol %.

4. The method according to claim 1 or 2, wherein the liquid carbon sources are any one, or more than one, selected from various hydrocarbon sources such as xylene, toluene, benzene and the like.

5. The method according to claim 1 or 2, wherein the metal catalyst particles are any one, or more than one, selected from various metal particles such as iron, nickel, cobalt, molybdenum and the like.

6. The method according to claim 1 or 2, wherein, in the step of producing precursors by instantaneously evaporating and atomizing the liquid metal catalyst mixture using an ultrasonic vibration method, liquid droplets of the liquid metal catalyst mixture are dropped on the ultrasonic vibration plate in the evaporation unit using a syringe pump, but a time for operating the ultrasonic vibration plate is controlled such that the ultrasonic vibration plate is not operated when the liquid droplets of the liquid metal catalyst mixture are not dropped thereon and the ultrasonic vibration plate is operated when liquid droplets of the liquid metal catalyst mixture are dropped thereon, and intensity of operation of the ultrasonic vibration plate is controlled depending on an amount and kind of the liquid metal catalyst mixture, thereby evaporating and atomizing the liquid metal catalyst mixture.

7. The method according to claim 1 or 2, wherein, as an apparatus for supplying the liquid metal catalyst mixture, a syringe pump is used, or a general quantitative liquid pump is used depending on an increase of an amount thereof.

8. The method according to claim 1 or 2, wherein an ultrasonic evaporator for evaporating the liquid metal catalyst mixture is configured to easily an automatically control operation time using an ON/OFF timer depending on amount and kinds of the supplied liquid metal catalyst mixture, and to easily control operation intensity thereof by coordinating variation of the liquid metal catalyst mixture to variation of voltage supplied to the evaporator.

9. The method according to claim 1 or 2, wherein the shape of the synthesized carbon nanotubes is controlled depending on conditions such as temperature, time, metal catalyst concentration, and the like.

10. The method according to claim 1, wherein the carbon nanotubes are vertically synthesized on an entire surface (an entire exposed surface) of quartz, which can be used as a large area substrate, in large quantities.

11. The method according to claim 1, wherein the carbon nanotubes are grown in a vapor phase state in a reactor, and are continuously synthesized.
